(19) United States
(12) Patent Application Publication
(10) Pub. No.: US 2026/0185379 A1
(43) Pub. Date: Jul. 2, 2026

(54) HOME APPLIANCE

(71) Applicant: LG Electronics Inc., Seoul (KR)

(72) Inventors: Jaehyun RA, Seoul (KR); Sang Woo WOO, Seoul (KR); Jin Woo SHIM, Seoul (KR); Jayhee PARK, Seoul (KR); Seunghoon LEE, Seoul (KR)

(21) Appl. No.: 19/418,216

(22) Filed: Dec. 12, 2025

(30) Foreign Application Priority Data
Dec. 30, 2024 (KR) 10-2024-0199775
May 21, 2025 (KR) 10-2025-0066110

(51) Int. Cl. E05B 1/00; A47L 15/42; F25D 23/02

(52) U.S. Cl. CPC E05B 1/0015; A47L 15/4257; E05B 2001/0023; F25D 23/028

(57) ABSTRACT

A home appliance includes a door; a handle configured to extend from the door or retract into the door, wherein a handle movement mode of the handle is selected by a user; and a sensor disposed on the door or the handle and configured to sense an input from the user. The home appliance receives the handle movement mode of the handle selected by the user, and extends or retracts the handle from or into the door or maintains a position of the handle in the extended state, based on the selected handle movement mode and a detection signal from the sensor.

### CROSS-REFERENCE TO RELATED APPLICATION

This application claims priority from Korean Patent Application No. 10-2024-0199775, filed on Dec. 30, 2024, and Korean Patent Application No. 10-2025-0066110, filed on May 21, 2025, in the Korean Intellectual Property Office, which are hereby incorporated by reference in their entirety.

### BACKGROUND

### Field

The present disclosure relates to a home appliance, and more particularly, to a home appliance having a handle having extended from a door.

### Description of Related Art

In general, a plurality of home appliances may exist in the house. For example, in the house, various home appliances that provide convenience of life, such as a dishwasher, a clothes care device, a laundry treating apparatus, a dryer, a refrigerator, etc. may exist.

The home appliance may be provided with a door for opening and closing an inner space thereof, and the door may be provided with a handle griped by a user.

### SUMMARY

A purpose to be achieved by the present disclosure is to provide a home appliance having a handle to extend from a door, wherein a user may select and change a handle movement mode of the handle according to a preference or environment.

In addition, a purpose to be achieved by the present disclosure is to provide a home appliance capable of automatically or semi-automatically retracting a handle having extended from a door or maintaining a position of the handle in the extended state according to a handle movement mode selected by a user.

In addition, a purpose to be achieved by the present disclosure is to provide a home appliance that automatically retracts a handle having extended from a door.

In addition, a purpose to be achieved by the present disclosure is to provide a home appliance capable of semi-automatically retracting a handle having extended from a door.

In addition, a purpose of the present disclosure is to provide a home appliance capable of maintaining a position of a handle having extended from a door in a fixed state.

The technical purposes to be achieved according to an embodiment of the present disclosure are not limited to the above-mentioned technical purposes, and other technical purposes not mentioned may be clearly understood by those skilled in the art from the following description.

In the home appliance according to an embodiment of the present disclosure, the user may select and change the handle movement mode to extend or retract the handle from or into the door according to a user's preference or environment, and a controller of the home appliance may allow extending out or retracting of the handle from or into the door to be executed based on the handle movement mode selected by the user.

According to an embodiment of the present disclosure, the handle movement mode may be selected and changed by a user, and the handle may extend or retract from or into the door or a position of the handle may be fixed in the extended state, based on a signal of a sensor and the selected or changed handle movement mode.

In addition, in response to that the handle movement mode is set to an automatic retracting mode, the home appliance according to an embodiment of the present disclosure may determine whether a handle holding maintaining condition is satisfied based on at least one of the detection signal of the sensor and the elapsed time duration, and may retract the handle into the front panel of the door based on the determination result.

In addition, in response to that the handle movement mode is set to a semi-automatic retracting mode and a user command is input, the home appliance according to an embodiment of the present disclosure may extend or retract the handle from or into the door based on the current position of the handle.

In addition, in response to that the handle movement mode is set to a handle position fixing mode, the home appliance according to an embodiment of the present disclosure may fix the position of the handle in the extended state. In response to that a signal corresponding to deactivation of the handle position fixing mode is input from an external terminal, the home appliance according to an embodiment of the present disclosure may retract the handle into the door.

As described above, the home appliance of the present disclosure may be configured to allow the user to select or change the handle movement mode to extend or retract the handle from or into the door according to a user's preference or environment.

In addition, the home appliance of the present disclosure may automatically extend or retract the handle from or into the front panel of the door or fix the position of the handle in the extended state based on the handle movement mode as selected or changed by the user.

In addition, in response to that the user selects or changes the handle movement mode as or to the automatic retracting mode, the home appliance of the present disclosure may automatically retract the extended handle to the front panel of the door on the basis of the detection signal of the sensor and the elapsed time duration.

In addition, in response to that the user selects or changes the handle movement mode as or to the semi-automatic retracting mode and the two-touch on the handle which has extended is sensed, the home appliance of the present disclosure may retract the handle into the front panel of the door.

In addition, in response to that the user selects or changes the handle movement mode as or to the handle position fixing mode, the home appliance of the present disclosure may maintain the extended state of the handle in the fixed manner.

In addition, in response to that the human hand being caught into between the handle and the door is detected while retracting the extended handle into or toward the front panel of the door, the home appliance of the present disclosure may automatically stop the retracting movement and extend out the handle, thereby preventing the hand from being damaged due to the hand pinching.

In addition, the home appliance of the present disclosure may allow the user to select or change the handle movement mode and control the extended state of the handle according to a user's preference or environment, thereby satisfying the requirements of various users.

For example, for a user who uses a home appliance less frequently but more frequently moves around in the kitchen, it may be convenient to keep the handle being received in the door rather than in a state in which the handle has extended from the door. In addition, even when a flat aesthetic sense of the door is desired, it may be preferable to maintain the retracted state of the handle.

In addition, for a user who uses a home appliance frequently or has difficulty in manipulating the home appliance in the electronic control manner, it may be convenient to keep the handle always in a state in which the handle has extended from the door.

As described above, the home appliance of the present disclosure may allow the user to select or change the handle movement mode according to the user's requirements, thereby improving user convenience and allowing changing of the design.

The effects of the present disclosure are not limited to the above-mentioned effects, and other effects not mentioned will be clearly understood by those skilled in the art from the following descriptions.

### BRIEF DESCRIPTION OF DRAWINGS

FIG. 1 is a front perspective view of a dishwasher according to an embodiment o the present disclosure.

FIG. 2 is a schematic cross-sectional view of the dishwasher as shown in FIG. 1.

FIG. 3 is a diagram illustrating a state in which a handle of a dishwasher according t an embodiment of the present disclosure is hidden inside a door.

FIG. 4 is a diagram illustrating a state in which a handle of a dishwasher according to an embodiment of the present disclosure has maximally extended.

FIG. 5 is a side view illustrating a state in which the handle as illustrated in FIG. 4 has maximally extended.

FIG. 6 is a side view illustrating a state in which a handle of a dishwasher according to an embodiment of the present disclosure has partially extended.

FIG. 7 is an exploded perspective view of a handle of a dishwasher according to an embodiment of the present disclosure.

FIG. 8 is an enlarged perspective view of a handle of a dishwasher according to an embodiment of the present disclosure.

FIG. 9 is a side cross-sectional view of the handle of FIG. 8.

FIG. 10 is a diagram illustrating a position of a first sensor provided at a lower end of a door of a dishwasher according to an embodiment of the present disclosure.

FIG. 11 is a block diagram of a control device of a dishwasher according to an embodiment.

FIG. 12 is a flowchart illustrating a control method in an automatic retracting mode of a dishwasher according to an embodiment of the present disclosure.

FIG. 13 is a flowchart illustrating a control method in a semi-automatic retracting mode of a dishwasher according to an embodiment of the present disclosure.

FIG. 14 is a flowchart illustrating a control method in a handle position fixing mode of a dishwasher according to an embodiment of the present disclosure.

FIG. 15 is a block diagram of an example of a control device in a dishwasher according to an embodiment.

FIGS. 16 and 17 are diagrams for illustrating human hand sensing by a sensor disposed in a handle.

### DETAILED DESCRIPTIONS

The above-described purposes, features, and advantages will be described in detail with reference to the accompanying drawings, and accordingly, a person having ordinary skill in the art to which the present disclosure pertains will be able to easily implement the technical idea of the present disclosure. In the description of the present disclosure, when it is determined that a detailed description of a known technology related to the present disclosure may unnecessarily obscure the gist of the present disclosure, the detailed description will be omitted. Hereinafter, preferred embodiments according to the present disclosure will be described in detail with reference to the accompanying drawings. In the drawings, the same reference numerals are used to indicate the same or similar components.

Although the first, second, and the like are used to describe various components, it is obvious that these components are not limited by these terms. These terms are used to distinguish only one component from another component. Unless otherwise stated, the first component may be the second component.

The present disclosure is not limited to the embodiments disclosed below, but various changes may be applied thereto and the present disclosure may be implemented in various different forms. However, the present embodiment is provided so that the present disclosure is complete and the scope of the present disclosure is fully informed to those skilled in the art. Therefore, embodiments of the present disclosure are not limited to the embodiments disclosed below, but it should be understood that a configuration of one embodiment and a configuration of another embodiment are substituted with each other or are added to each other, and all changes, equivalents, and substitutes included in the technical spirit and scope of the present disclosure are included in the present disclosure.

The accompanying drawings are only set forth for easy understanding of the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed to be larger or smaller in size or thickness in consideration of convenience of understanding, etc. However, the scope of the present disclosure should not be limited thereto.

The terms used herein are used only to describe specific embodiments or embodiments, and are not intended to limit the present disclosure. As used herein, the singular constitutes “a” and “an” are intended to include the plural constitutes as well, unless the context clearly indicates otherwise In the present disclosure, terms such as “include” and “comprise” are intended to designate that a feature, a number, a step, an operation, a component, a part, or a combination thereof as described in the present disclosure exist. That is, it should be understood that in the present disclosure, the terms such as “include” and “comprise” do not exclude the presence or addition of one or more other features, numbers, steps, operations, components, parts, or combinations thereof.

Terms including ordinals, such as first, second, etc., may be used to describe various components, but the components are not limited by the terms. The terms are used only for the purpose of distinguishing one component from another component.

When it is mentioned that one component is “connected” or “coupled” to another component, it should be understood that one component may be directly connected or coupled to another component, or still another component may be present therebetween. On the other hand, when it is mentioned that one component is “directly connected” or “directly coupled” to another component, it should be understood that still another component is absent therebetween.

When one component is referred to as “being disposed on top of” or “being disposed under” another component, it should be understood that one component may be directly disposed on top of or under another component or still another component may be present therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a home appliance capable of automatically or semi-automatically retracting a handle having extended from a front panel of a door or changing a state of the handle to a fixed state, and a control method thereof will be described with reference to the drawings showing a configuration according to an embodiment of the present disclosure.

In the present disclosure, an example in which the home appliance is embodied as a dishwasher 1 for convenience of description is described. However, embodiments of the present disclosure are not limited thereto. In another example, the home appliance may be embodied as a home appliance configured such that a door and a handle are visible to an outside, such as a dishwasher, a clothes care device, a laundry treating apparatus, a dryer, and a refrigerator.

In addition, in the present disclosure, an example in which the home appliance i embodied as a dishwasher having a door opened and closed in a hinge manner. However, embodiments of the present disclosure are not limited thereto. In another example, the home appliance may be embodied as a home appliance having a door that is opened and closed in a drawer manner.

In the present disclosure, a front-rear direction refers to a direction based on front and rear sides of the dishwasher 1, and a left-right direction refers to a direction based on lateral sides of the dishwasher 1. A user uses the dishwasher 1 while being positioned in front of the dishwasher 1.

In the present disclosure, an outward direction of the door 30 may be defined as a frontward direction of the dishwasher 1.

### Overall Structure of Dishwasher

Hereinafter, the overall structure of the dishwasher 1 according to the present disclosure will be described in detail with reference to the accompanying drawings.

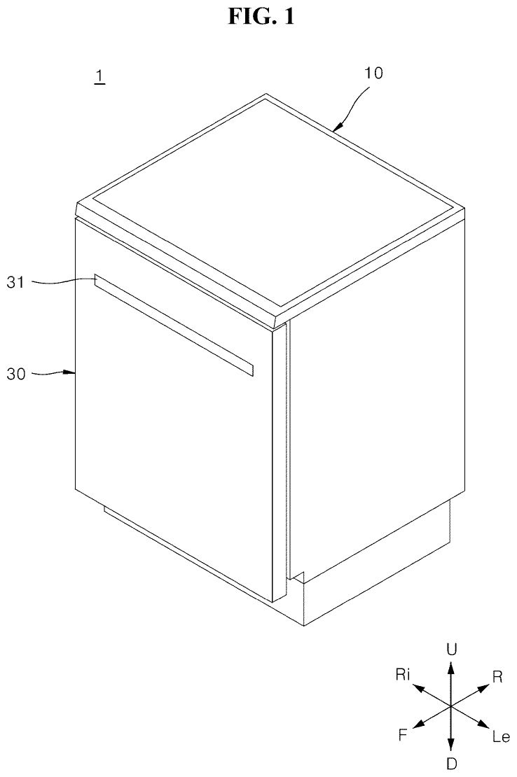

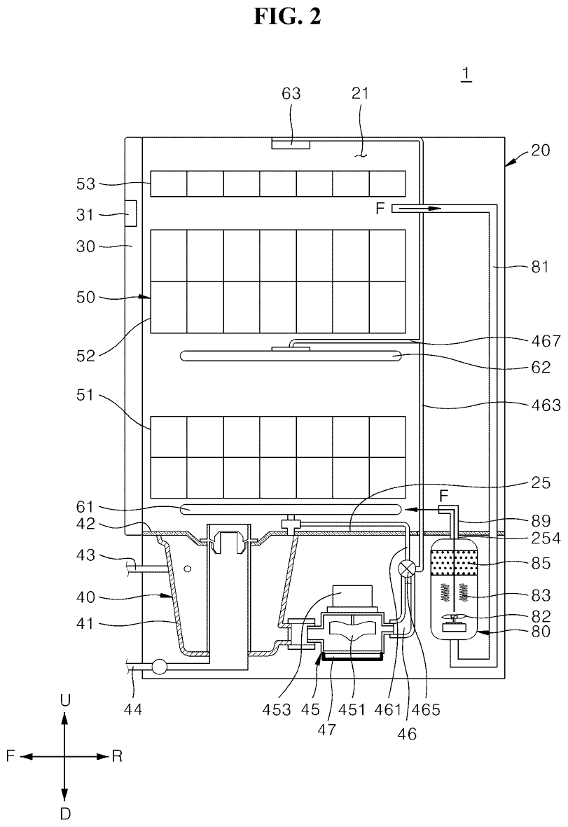

FIG. 1 is a front perspective view of a dishwasher according to an embodiment o the present disclosure. FIG. 2 is a schematic cross-sectional view of the dishwasher as shown in FIG. 1.

As shown in FIG. 1 and FIG. 2, a dishwasher 1 according to the present disclosure may include a casing 10 that constitutes an exterior appearance, a tub 20 installed in an inner space of the casing 10 and having a washing space 21 defined therein where the washing target is washed, wherein a front surface of the tub is open, a door 30 that opens/closes the open front surface of the tub 20, a driver device 40 located under the tub 20 to heat, supply, collect, circulate, and discharge the washing water for washing the washing target, a dish rack 50 removably provided in the inner washing space 21 of the tub 20 to receive therein the washing target, and a water sprayer 61, 62, and 63 installed adjacent to the dish rack 50 to spray the washing water for washing the washing target thereto.

In this regard, the washing target received in the dish rack 50 may be, for example, dishes such as bowls, plates, spoons, and chopsticks, and other cooking utensils. Hereinafter, unless otherwise specified, the washing target will be referred to as a dish.

The tub 20 may be formed in a box shape in which a front surface 22 is entirely open, and each of a rear surface 23, an upper surface 24, the lower surface 25, a right surface 27, and a left surface is in a closed state, and corresponds to a part known as a so-called washing tub.

A washing space 21 may be formed inside the tub 20, and the open front surface of the tub 20 may be opened and closed by a door 30.

The tub 20 may be formed via pressing of a metal plate resistant to high temperature and moisture, for example, a stainless steel plate.

Moreover, on an inner surface of the tub 20, a plurality of brackets may be disposed for the purpose of supporting and installing functional components such as the dish rack 50 and the water sprayer which will be described later thereon within the tub 20.

The driver device 40 may be configured to include a sump 41 for storing therein washing water used for washing and rinsing the washing target, a sump cover 42 for distinguishing the sump 41 from the tub 20, a water supply 43 for supplying the washing water from an external source to the sump 41, a water discharger 44 for discharging the washing water of the sump 41 out of the sump, a washing pump 45 for supplying the washing water of the sump 41 to the sprayer, a heating heater 47 for heating the washing water, and a supply flow path 46.

The sump cover 42 may be disposed at a top of the sump 41 and may serve to distinguish the tub 20 from the sump 41. Moreover, the sump cover 42 may have a plurality of collecting holes defined therein for collecting washing water sprayed into the washing space 21 through the water sprayer into the sump 41. The washing water sprayed from the water sprayer 61, 62, and 63 toward the dish may fall down to a bottom of the washing space 21, and may be collected again through the sump cover 42 and into the sump 41.

The washing pump 45 may be disposed at a side or a bottom of the sump 41 and may serve to pressurize the washing water and supply the pressurized washing water to the water sprayer. One end of the washing pump 45 may be connected to the sump 41 and the other end thereof may be connected to the supply flow path 46. The washing pump 45 may be equipped with an impeller 451 and a motor 453. When power is supplied to the motor 453, the impeller 451 may rotate, and thus the washing water in the sump 41 may be pressurized, and then may be supplied to the water sprayer through the supply flow path 46.

A heater assembly including a heating heater 47 may be disposed at a bottom surface of a housing of the washing pump 45. The heating heater 47 may be used to heat the washing water to be supplied to the washing pump 45. The heating heater 47 may heat the washing water used for washing and rinsing the washing target to a target temperature based on a control signal of a controller. For example, the heating heater 47 may heat the washing water based on a control signal corresponding to a washing cycle. In addition, the heating heater 47 may heat the washing water based on a control signal corresponding to a rinsing process. In addition, the heating heater 47 may heat the washing water based on a control signal corresponding to whether moisture-absorbing and drying is activated.

In addition, the heating heater 47 may heat the washing water to a varying target temperature in the washing cycle or the rinsing cycle in response to a control signal of the controller. In addition, the heating heater 47 may heat the washing water supplied in the rinsing process to a target temperature varying based on whether the moisture-absorption and drying is activated in response to the control signal of the controller. For example, the heating heater 47 may heat the washing water in the rinsing process to a higher temperature when the moisture-absorption and drying is activated than that when the moisture-absorption and drying is deactivated.

In one example, the supply flow path 46 may serve to selectively supply the washing water supplied from the washing pump 45 to the water sprayer.

For example, the supply flow path 46 may include a first supply flow path 461 connected to a lower spraying arm 61, and a second supply flow path 463 connected to an upper spraying arm 62 and a top nozzle 63. The supply flow path 46 may be provided with a supply flow path switching valve 465 that selectively opens/closes the supply flow paths 461 and 463.

In this regard, the supply flow path switching valve 465 may be controlled so that the supply flow paths 461 and 463 are opened sequentially or simultaneously.

In one example, the water sprayer may be configured to spray the washing water to the dishes stored in the dish rack 50.

More specifically, the water sprayer may include the lower spraying arm 61 located under the tub 20 to spray the washing water to a lower rack 51, the upper spraying arm 62 located between the lower rack 51 and an upper rack 52 to spray the washing water to the lower rack 51 and the upper rack 52, and the top nozzle 63 located on top of the tub 20 to spray the washing water to a top rack 53 or the upper rack 52.

In particular, the lower spraying arm 61 and the upper spraying arm 62 may be rotatably disposed in the washing space 21 of the tub 20 and may spray the washing water toward the dish of the dish rack 50 while being rotating.

The lower spraying arm 61 may be rotatably supported on a top of the sump cover 42 so as to spray the washing water toward the lower rack 51 while being rotating and being disposed under the lower rack 51.

Moreover, the upper spraying arm 62 may be rotatably supported by a spraying arm holder 467 so as to spray the washing water on the dish while being rotating and being disposed between the lower rack 51 and the upper rack 52.

In one example, although not shown, in order to increase washing efficiency, additional means for diverting the washing water sprayed from the lower spraying arm 61 into an upward direction (diverting in a U-direction) may be provided at a lower surface 25 of the tub 20.

The dish rack 50 for storing the dish therein may be disposed in the washing space 21. The dish rack 50 may be configured to extend or retract from or into the inner space of the tub 20 through the open front surface of the tub 20.

For example, in FIG. 2, an embodiment is shown in which the dish rack 50 includes the lower rack 51 located at a lower portion of the tub 20 to accommodate therein relatively large dishes, the upper rack 5 located on top of the lower rack 51 to accommodate therein medium-sized dishes, and the top rack 53 located at a top level of the tub 20 and capable of storing therein small dishes, etc. However, However, embodiments of present disclosure are not limited thereto. However, hereinafter, an example in which the dishwasher 1 includes the three dish racks 50 as shown is described.

Each of the lower rack 51, the upper rack 52, and the top rack 53 may be configured to extend or retract from or into the inner space of the tub 20 through the open front surface of the tub 20.

For this purpose, guide rails 54 may be respectively disposed on both opposing inner side surfaces constituting an inner surface of the tub 20. By way of example, the guide rails may include an upper rail 542, a lower rail 541, and a top rail 543.

Wheels may be disposed on a bottom of each of the lower rack 51, the upper rack 52, and the top rack 53. The user may extend the lower rack 51, the upper rack 52, and the top rack 53 from the inner space of the tub 20 through the open front surface of the tub 20 and may place the dishes thereon, or easily extend the dishes that have been washed out thereof.

The guide rail (not shown) may be embodied as a simple rail-type fixed guide rail to guide the extending or the retracting of the rack 50, or a telescopic guide rail capable of guiding the extending or the retracting of the rack 50 and at the same time, increasing an extension distance thereof as the rack 50 further extends from the inner space of the tub.

Although not shown, the rear panel 30b defining the inside of the door 30 may further be provided with a detergent supply device for automatically supplying detergent into the inside of the tub 20.

Furthermore, a door position sensor may be disposed on an outer top surface of the tub 20 and may be configured to detect whether the door 30 is in a closed or open state. For example, the door position sensor may include a door position sensor or a latch sensor or a limit sensor that detects a position of a door latch (not shown).

In one example, a moisture absorption and drying device 80 may be provided under the tub 20 and be configured to absorb water vapor contained in the air discharged from the tub 20 during the drying cycle and then resupply the water-vapor-free air to the tub 20 again.

The moisture absorption and drying device 80 may include a suction duct 81 through which air discharged from the tub 20 is sucked, a blower 82 for generating an airflow of the air, a heater 83 for heating the air sucked from the tub 20, and a moisture absorbent 85 for absorbing the water vapor contained in the air.

An air supply hole 254 through which the air from which the water vapor has been removed through the moisture adsorption and drying device 80 is introduced into the tub 20 may be defined in a lower surface 25 of the tub 20.

The airflow supplied into the tub 20 and then becoming humid while drying the dishes may be discharged to the outside, and the discharge of the airflow may be performed through partial opening of the door 30 or through a separate exhaust means (not shown).

As the dry air from the moisture-absorption and drying device 80 is supplied t the inside of the tub 20 during the drying process, the drying efficiency and sterilization effect of dishes may be significantly improved.

The door 30 has a purpose for opening and closing the open front surface of the tub 20 as described above. A hinge (not shown) around which the door 30 is closed or opened may be provided at a bottom of the open front surface. Thus, the door 30 may pivot around the hinge as a pivot axis.

A rear panel 30b constituting an inner side surface of the door 30 may constitute one surface of the tub 20 when the door 30 has been closed, and may constitute a seat surface on which the lower rack 51 of the dish rack 50 is supported when the door 30 is fully opened.

For this purpose, when the door 30 is fully opened downwardly, the rear panel 30b of the door 30 may constitute a horizontal plane extending in the same direction as a direction in which the guide rail 54 guiding the displacement of the lower rack 51 extends.

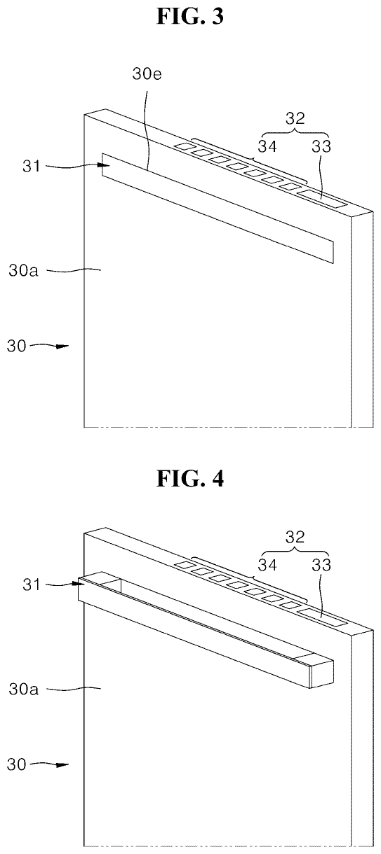

Referring to FIGS. 3 and 4, a handle 31 for opening the door 30 and a control panel 32 for controlling the operation of the dishwasher 1 may be provided on an outer surface of the door 30.

The control panel 32 may include a display 33 that visually displays information regarding a current operating status of the dishwasher 1, etc., and a button unit 34 including a selection button through which a user's course selection manipulation is input and a power button through which a user's manipulation for turning the dishwasher on and off is input.

The handle 31 of the dishwasher 1 according to the present disclosure may be configured to be at least partially accommodated in an inside of the door 30 when the handle is not in use, and to automatically extend in a protruding manner in a frontward direction from the door 30 when it is necessary to open and close the door 30.

In that the handle is configured to retract so as to be at least partially accommodated in the inside of the door 30 or extend in a protruding manner in a frontward direction from the door 30 out of the inside of the door 30, the handle 31 may be referred to as various names such as a pop-up handle, a retractable handle, an extendable handle, etc. Hereinafter, the handle 31 configured to retract into or extend from the door 30 of the dishwasher 1 according to one embodiment of the present disclosure will be referred to as the handle 31.

### Appearance and Operation of Handle

Hereinafter, with reference to FIGS. 3 to 6, the appearance and the operation of the handle 31 disposed at the door 30 of the dishwasher 1 according to one embodiment of the present disclosure will be described in detail.

As described above, the front panel 30a of the door 30 of the dishwasher 1 according to one embodiment of the present disclosure may be provided with the handle 31 that may be reciprocally movable in the front-rear direction. In this regard, as described above, the door 30 may be configured to be pivotable around the hinge (not shown) connected to a lower end of the door.

The handle 31 may be positioned at a position close to a top surface of the door 30 where the user may easily grasp the handle, and may be disposed at the front panel 30a constituting the front surface of the door 30 and may extend from or retract into the door.

Furthermore, the handle 31 may extend along an extension direction of a front edge of the top surface of the door 30 and along a left-right direction so that the user may easily grasp the handle. The handle 31 may be formed to have an approximate 90 degrees-rotated U shape.

In order to extend or retract the handle 31, an elongate opening 30e having a shape corresponding to an appearance of the handle 31 may be defined in the front panel 30a of the door 30 and extend along the extension direction of the front edge of the top surface of the door 30, and have a depth along a front-rear (F-R) direction

The handle 31 may be configured to reciprocate along the in a frontward direction and backward directions through the opening 30e of the front panel 30a under an operation of a handle driver as described below.

More specifically, the handle 31 may be disposed to reciprocate between the most frontward position and the most rearward position under the operation of the handle driver. In addition, the handle 31 may partially extend in a frontward direction according to the operation of the handle driver.

For convenience, hereinafter, the most frontward position to which the handle 31 is displaced in a frontward direction is defined as a maximally-extended position Pd2 or a second position Pd2. The most rearward position to which the handle 31 is displaced in a backward direction is defined as an inserted position Pa. In addition, a position where the handle 31 has partially extended in a frontward direction is defined as a partially-extended position Pd1 or a first position Pd1.

FIG. 3 illustrates a state where the handle 31 has been displaced to the most rearward position, that is, the inserted position Pa, and thus has retracted into the inside of the door 30.

As shown, when the handle 31 has been displaced to the inserted position Pa, the handle 31 has at least partially retracted into the inside of the door 30. In this regard, preferably, the handle 31 may pass through an entirety of the opening 30e of the door 30 and retract into the inside of the door 30.

Furthermore, when the handle 31 has been displaced to the inserted position Pa, the handle 31 may be in a state where the handle 31 does not protrude from the front panel 30a of the door 30 in a frontward direction. Furthermore, when the handle 31 has been displaced to the inserted position Pa, a front end surface of the handle 31 may be coplanar with a front surface of the front panel 30a of the door 30 so as to form a continuous surface.

That is, when the handle 31 has been displaced to the inserted position Pa, a state in which no step is formed between the front surface of the front panel 30a of the door 30 and the front end surface of the handle 31 while an entirety of the opening 30e of the door 30 is closed may be formed. Thus, when the handle 31 has been displaced to the inserted position Pa, the opening 30e of the front panel 30a is entirely blocked, and at the same time, no step is formed between the front surface of the front panel 30a and the front end surface of the handle 31, such that the phenomenon in which foreign substances such as dusts accumulate on an convex portion of the door 30 or on the handle itself as in the conventional approach may be fundamentally prevented.

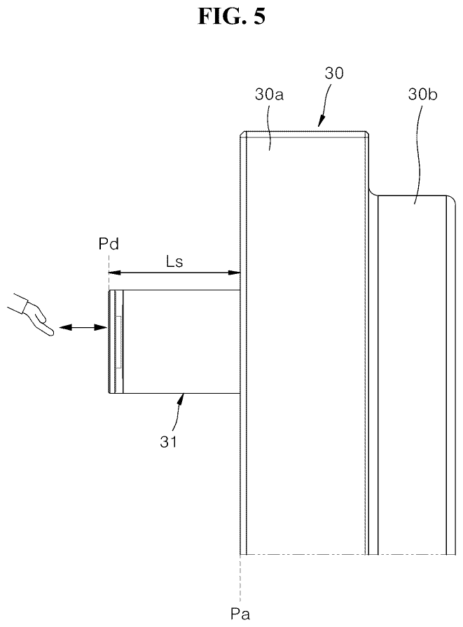

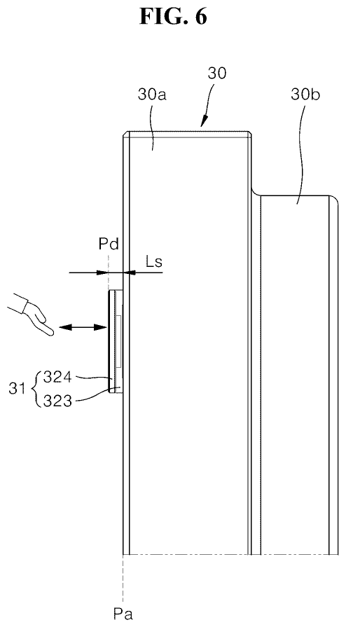

FIGS. 4 and 5 show a state in which the handle 31 has been displaced from the inserted position Pa to the maximally-extended position Pd2, and FIG. 6 shows a state in which the handle 31 has been displaced from the inserted position Pa to the partially-extended position Pd1 at which a portion of the handle has extended. In the present disclosure, the position at which the handle 31 has partially extended may be referred to as a partially-extended position Pd1 or the first position Pd1. In addition, the position at which the handle 31 has maximally extended may be referred to as the maximally-extended position Pd2 or the second position Pd2.

As shown in FIGS. 4 and 5, the handle 31 may extend from the inserted position Pa to the maximally-extended position Pd1. Moreover, as shown in FIG. 6, the handle 31 may extend from the inserted position Pa to the partially-extended position Pd1.

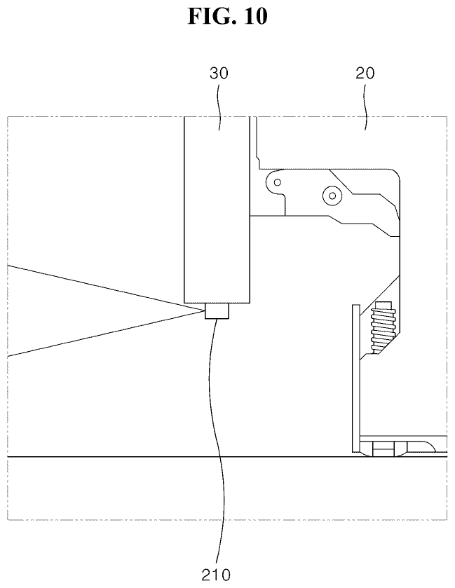

First, the handle 31 may extend to the partially-extended position Pd1 when a person is sensed by a first sensor 210 (shown in FIG. 10. The first sensor 210 may be provided at a lower end of the door 30 to maintain a seamless design of the front panel 30a of the door 30. For example, the first sensor 210 may be embodied as a proximity sensor. Alternatively, the first sensor 210 may be embodied as one of a RADAR (radio detection and ranging), a LIDAR (Light Detection Ranging), and a thermal sensor.

For example, the handle 31 may extend from the door by 5 mm in response to that the person has been detected by the first sensor 210. In an example, a stroke Ls by which the handle 31 is displaced from the inserted position Pa to the partially-extended position Pd1 may be in a range of 4 mm to 6 mm, preferably 5 mm. When the movement of the handle 31 to the partially-extended position Pd1 has been completed, a cover 324 and a light guide 323 of the handle 31 may be exposed. A first LED module 250 having a plurality of LED elements 3221 may be provided inside the handle 31, and light emitted from the first LED module 250 may be exposed through the light guide 323.

The determination of the displacement stroke Ls by which the handle 31 has partially extended is made in consideration of a distance by which the handle 31 is displaced so as to extend from the door such that the light emitted from the first LED module 250 may be exposed through the light guide 323 to the user. The displacement stroke Ls by which the handle 31 has partially extended is merely an example and may be designed to vary depending on a thickness of the light guide 323.

In addition, in response to that the person has been detected by the first sensor 210, the handle 31 may extend outwardly from the inside of the door 30 by 5 mm, and simultaneously, the first LED module 250 may be turned on to act as a preset welcome lighting. For example, the plurality of LED elements 3221 of the first LED module 250 may be turned on in an animation manner, and may be sequentially turned on a clockwise/counterclockwise rotation manner, or a left/right directional gradation manner (be sequentially turned on from a center to each of the left and right sides, or from each of the left and right sides to the center), thereby acting as the preset welcome lighting.

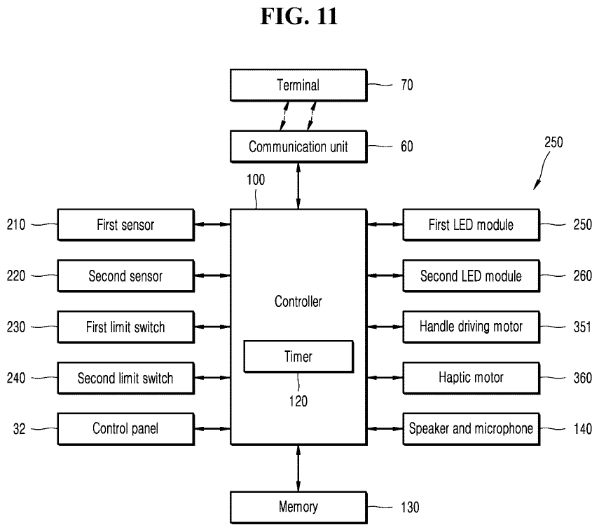

Next, the handle 31 may extend to the maximally-extended position Pd2 when a human hand is sensed by a second sensor 220 (shown in FIG. 11. The second sensor 220 may be provided inside the handle 31. The second sensor 220 is disposed in the inside of the handle 31, such that the front panel 30a of the door 30 may be maintained in a seamless design.

For example, the second sensor 220 may be embodied as a capacitance-based sensor capable of sensing a non-contact touch (air touch) or a contact touch. Thus, the second sensor 220 may sense the touch of the user on a front surface of the handle 31. The second sensor 220 may include a touch electrode, and the touch electrode may be mounted on a printed circuit board 322 provided in the handle. The second sensor 220 may detect the air touch or the contact touch based on a detecting result of a change in capacitance between the touch electrode and the user's hand. However, embodiments of the present disclosure are not limited thereto, and any means capable of detecting whether the user's hand is proximal to the handle may be applied as the second sensor 220 without limitations thereof.

When the movement of the handle 31 to the maximally-extended position Pd2 has been completed, a handle body 321 of the handle 31 may be in a state in which the handle body 321 is entirely exposed to the outside out of the door 30 and in a state in which the user may grip the handle body 321. As the handle 31 is displaced to the maximally-extended position Pd2, the handle body 321 of the handle 31 exits the opening 30e of the front panel 30a of the door 30 and is exposed to the outside out of the door 30.

For example, the displacement stroke Ls by which the handle 31 is displaced from the inserted position Pa to the maximally-extended position Pd2 may be in a range of 40 mm to 50 mm, preferably 45 mm. The displacement stroke Ls of the handle 31 is merely an example and may be designed to vary according to the overall size of the dishwasher 1 and the front-rear size of the door 30.

### Detailed Structure of Handle

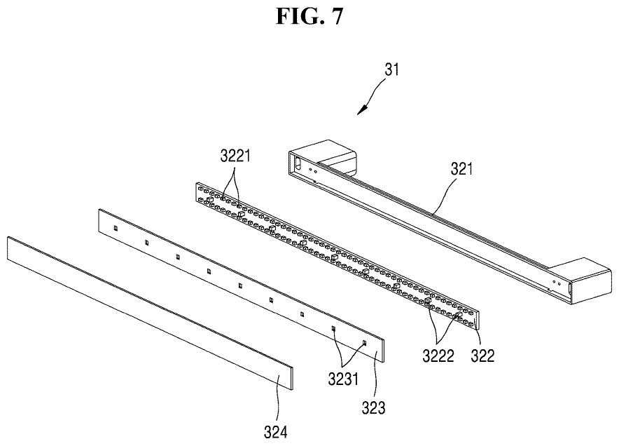

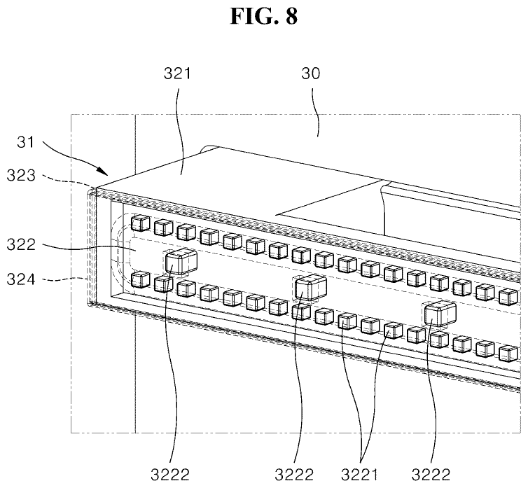

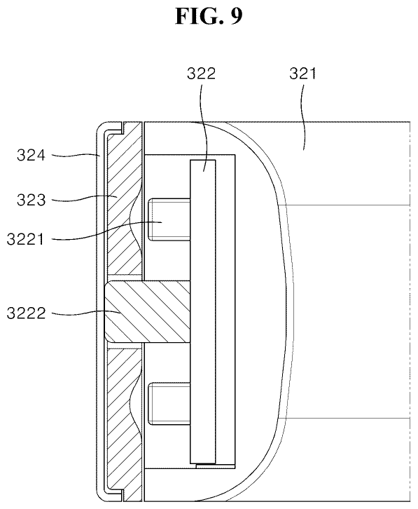

FIG. 7 is an exploded perspective view of a handle of a dishwasher according to an embodiment of the present disclosure. FIG. 8 is an enlarged perspective view of a handle of a dishwasher according to an embodiment of the present disclosure. FIG. 9 is a side cross-sectional view of the handle of FIG. 8.

Referring to FIG. 7, the handle 31 includes the handle body 321, the printed circuit board 322, the light guide 323, and the handle cover 324.

The handle body 321 extends in an elongate manner along the left-right direction and is disposed in the front panel 30a of the door 30 so as reciprocate in the front-rear direction. The handle body 321 includes a first handle body 321a and a second handle body 321b respectively coupled to both opposing sides in the left-right direction of the front panel 30a.

The handle driver may be disposed in each of the first handle body 321a and the second handle body 321b. A pair of handle drivers may be arranged so as to be spaced from each other along the left-right direction, and the driving forces respectively generated from the handle drivers may be transmitted to the first and second handles 321a and 321b, respectively. However, embodiments of the present disclosure are not limited thereto, and the handle 31 may be driven only by a single handle driver. In the present disclosure, a detailed configuration of the handle driver is not illustrated. However, the handle driver may include a pivot link having one end relatively pivotable with respect to the door and the other end connected to the handle to be relatively pivotable with respect thereto, a driving cam which presses the pivot link so that the pivot link pivots in a frontward direction when rotating in a forward direction, and presses the pivot link so that the pivot link pivots backwards when rotating in a reverse direction, and a handle driving motor 351 (shown in FIG. 11) which generates a rotational driving force for rotating the driving cam in the forward direction or the reverse direction.

The printed circuit board 322 may be disposed on a front surface of the handle body 321. The LED module having the plurality of LED elements 3221 is mounted on the printed circuit board 322. A plurality of gaskets 3222 for sensing proximity of a human hand is mounted on the printed circuit board 322. The plurality of gaskets 3222 may be connected to an internal touch electrode (not shown). For example, the touch electrode may be formed as a single plate-shaped structure. In another example, the touch electrode may be partitioned into a plurality of electrodes.

For example, respective one sides of the plurality of gaskets 3222 may be in contact with the handle cover 324, and the respective other sides of the plurality of gaskets 3222 may be electrically connected to the single plate-shaped touch electrode. The plurality of gaskets 3222 may be used to sense whether an air touch is made based on a change in capacitance of a capacitor between a human hand and a touch electrode when a user approaches the handle cover 324. In this case, the plurality of gaskets 3222 may be used to detect a position on the handle cover 324 which the hand approaches.

In another example, the respective one sides of the plurality of gaskets 3222 may be in contact with the handle cover 324, while the respective other sides of the plurality of gaskets 3222 may be electrically connected to a plurality of corresponding touch electrodes, respectively. For example, one gasket 3222 may be individually connected to one touch electrode. In this case, the plurality of gaskets 3222 may be used to detect a position on the handle cover 324 which the hand approaches or touches. The function of the dishwasher 1 may be controlled according to the touch position of the handle cover 324 by the hand. For example, when the hand touches the left or right edge of the handle cover 324, a pause function may be executed during the washing, rinsing, or drying cycle of the dishwasher 1. In addition, when the hand touches a middle area of the handle cover 324, a function may be executed so that the handle 31 extends to the maximally-extended position Pd2.

The plurality of LED elements 3221 may be disposed on each of upper and lower portions of a front surface of the printed circuit board 322 and may be arranged along a periphery of the handle 31. For example, the plurality of LED elements 3221 may be densely arranged along the periphery of the handle 31 so as to enable dynamic turn signal control.

The plurality of LED elements 3221 may be configured to be turned on in an animation manner, and to be sequentially turned on a clockwise/counterclockwise rotation manner, or a left/right directional gradation manner (be sequentially turned on from a center to each of the left and right sides, or from each of the left and right sides to the center), thereby acting as the preset welcome lighting. In addition, the plurality of LED elements 3221 may be configured to emit light such that a color of the light may vary according to a washing, rinsing, or drying process. In addition, the plurality of LED elements 3221 may be configured such that the number of turned on LED elements 3221 arranged in the left-right direction gradually increases according to the elapsed time duration of the washing, rinsing, or drying process. In addition, the plurality of LED elements 3221 may be configured to emit red light for a notification for preventing hand pinching. In addition, the plurality of LED elements 3221 may be configured to emit light such that the color of the light may vary according to the internal temperature of the dishwasher 1 when the user temporarily stops the operation of the dishwasher 1 and attempts to open the door 30.

The plurality of gaskets 3222 may be arranged along a middle line in a vertical direction of the front surface of the printed circuit board 322 and in the left-right direction. For example, the plurality of gaskets 3222 may be arranged along the left-right direction and in the middle line disposed between the upper array and the lower array of the plurality of LED elements 3221 disposed on the front surface of the printed circuit board 322.

The light guide 323 may be disposed on the front surface of the printed circuit board 322, and each gasket hole 3231 for guiding each of the plurality of gaskets 3222 to contact the handle cover 324 may be formed in the light guide 323. The gasket holes 3231 may be arranged along the vertical middle line and in the left-right direction. The light guide 323 may be made of a light guide material that diffuses light when the plurality of LED elements 3221 emit the light. The light guide 323 may be exposed in the frontward direction when the handle 31 has extended out of the door 30, and may diffuse the light from the plurality of LED elements 3221 along the periphery of the handle 31.

The handle cover 324 is disposed on a front surface of the light guide 323 and is in physical contact with the respective one sides of the plurality of gaskets 3222. For example, the handle cover 324 may be formed to have the same texture as that of the front panel 30a of the door 30. For example, the handle cover 324 may be made of a metal material when the second sensor 220 is embodied as a sensor configured to sense a non-contact touch of one point. Alternatively, the handle cover 324 may be made of a non-metal material when the second sensor 220 is embodied as a sensor configured to sense a non-contact touch of a plurality of points.

### Device and Method for Controlling Handle

FIG. 11 is a block diagram of a control device of a dishwasher according to an embodiment.

Referring to FIG. 11, the control device of the dishwasher 10 includes the first sensor 210, the second sensor 220, a first limit switch 230, a second limit switch 240, a control panel 32, the first LED module 250, a second LED module 260, the handle driving motor 351, a haptic motor, a speaker and a microphone 140, and a controller 100.

The first sensor 210 detects a person within a first distance from the dishwasher 1. The first sensor 210 may be provided at the lower end of the door 30 to maintain the seamless design of the front panel 30a of the door 30. In addition, the first sensor 210 may be used as a sensor for activating a sensing function of the second sensor 22.

In response to that the person approaches a position within the first distance from the dishwasher 1 based on a spacing of the person sensed by the first sensor 210 from the dishwasher 1, the controller 100 may be configured to allow the handle 31 to extend to the first position Pd1. For example, the first distance may be set to 50 cm from the dishwasher 1, and the first position Pd1 may be set to a position corresponding to the displacement stroke Ls of 5 mm. In an example, the controller 100 may be configured to allow the handle 31 to be displaced to the first position Pd1 when the person approaches a position within 50 cm from the dishwasher 1 and stays at the position within the first distance for 1 or larger second.

In addition, the controller 100 may be configured to activate the second sensor 220 in response to that the person approaches a position within the first distance from the dishwasher 1 based on the spacing between the person measured by the first sensor 210 and the dishwasher 1.

For example, the first sensor 210 may be embodied as a proximity sensor that detects the proximity of an object located in front of the dishwasher 1.

In another example, the first sensor 210 may be embodied as a position sensitive detector (PSD) sensor. The PSD sensor is a sensor for detecting a position using a light source. The PSD sensor is an optical sensor used to measure the position of incident light, and may determine the position of the object based on a measuring result of a current distribution generated when light or particles collide with a sensor surface. The PSD sensor may be referred to as a position detection sensor or a light position detector.

In still another example, the first sensor 210 may be embodied as a time of flight (TOF) sensor. The TOF sensor is a sensor that is configured to emit light of a specific wavelength, to measure a time for which the light is emitted to the object and is reflected from the object and retracts thereto, and to calculate the distance from the object based on the measured time. The TOF sensor accurately measures a round trip time of light, and calculates the distance between the object and the sensor in real time using the time duration for which the light is emitted to and is reflected from the object and retracts to the sensor.

In still yet another example, the first sensor 210 may be embodied as an ultrasonic sensor. The ultrasonic sensor is a sensor that is configured to transmit sound waves to the object and to receive reflected waves reflected form the object and to measure the distance to the object based on the reception of the reflected waves. The ultrasonic sensor may precisely calculate the distance to the object based on a measuring result of the time duration between the transmitting of the sound wave and the reception of the reflected wave.

In still yet another example, the first sensor 210 may be embodied as a radar sensor. The radar sensor may be configured to transmit radio waves, receive reflected waves, measure a time duration between the transmission and the reception of the radio waves, and to calculate the distance to the object based on the time duration. The radar sensor may monitor various information such as an angle, a position, and a speed of the object based on a phase difference between the transmitted wave and the reflected wave.

In still yet another example, the first sensor 210 may be embodied as a Lidar sensor. The Lidar sensor is configured to measure a time duration for which laser light is emitted toward and is reflected from the object and retracts thereto using a time of flight (TOF) principle and to calculate the distance to the object based on the measured time duration. The Lidar sensor may recognize a sensor value of surrounding environments while rotating by 360 degrees using a motor.

In still yet another example, the first sensor 210 may include a thermal sensor. The thermal sensor is a sensor configured to detect heat emitted from a human body or an object and identify the location of the object based on the analysis of the detected heat. The thermal sensor detects the object using infrared radiation energy and does not use light, so that it may work effectively even in dark environments.

The second sensor 220 detects the human hand within a second distance from the handle 31. The second sensor 220 may be provided inside the handle 31. The second sensor 220 may be received in the inside of the handle 31, such that the front panel 30a of the door 30 may be maintained in a seamless design. The second sensor 220 may be used to extend the handle 31 to the second position Pd2 when the human hand is sensed thereby. In addition, the second sensor 220 may be used to detect whether the user's hand is caught into between the handle 31 and the door 30.

The controller 100 may be configured to allow the handle 31 to extend to the second position Pd2 in response to that the human hand approaches a position within the second distance from the handle based on the signal sensed by the second sensor 220. For example, the second distance may be set to 5 cm, and the second position may be set to a position corresponding to the displacement stroke of the handle of 45 mm.

For example, the second sensor 220 may be embodied as a capacitance-based sensor capable of sensing a non-contact touch (air touch) or a contact touch of the front surface of the handle 31 by the user. The second sensor 220 may include the touch electrode, and the touch electrode may be mounted on the printed circuit board 322 provided inside the handle. The second sensor 220 may sense the air touch or the contact touch based on a sensing result of a change in capacitance between the touch electrode and the user's hand.

In another example, the second sensor 220 may be embodied as a capacitance-based sensor including a plurality of partitioned touch electrodes. A preset UI function may be performed according to a touch position or a touch pattern of the handle 31. For example, when a central portion of the handle 31 is touched by the user, a function of extending the handle to the second position Pd2 may be set to be performed. When a left portion or a right portion of the handle 31 is touched by the user, a function of temporarily stopping the operation of the dishwasher 1 or popping-in the handle into the first position Pd1 may be set to be performed. As described above, the handle 31 may be used as a means for performing the preset UI function.

In another example, the second sensor 220 may be disposed on the door 30. For example, the second sensor 220 may be disposed at one side of the front panel 30a of the door 30. When the user brings his/her hand close to one side of the front panel 30a at which the second sensor 220 has been disposed, the second sensor 220 may detect the user's indirect touch, direct touch, or touch pattern and provide a detection signal based on the detecting result to the controller 100.

In still another example, the second sensor 220 may be embodied as a sensor that detects a user's input. For example, various sensors such as a proximity sensor, an infrared sensor, an ultrasonic sensor, an RGB camera or an IR camera for recognizing a hand shape, a gesture, or a motion, a non-contact proximity sensor, a sensor for sensing a touch or a contact, or a capacitive type sensor or a piezoelectric type sensor may be used as the sensor for sensing the user's input.

In the present disclosure, an example in which the sensing of the user's input includes sensing a human hand or sensing a hand shape, gesture, or movement is set forth. An example of the user's command input may include a simple touch, a two-touch, a control panel button input, a display input, etc.

The handle driving motor 351 is used to reciprocate the handle in the front-rear direction. The handle driving motor 351 may be included in the handle driver provided in each of the first and second handle bodies 321a and 321b. The handle driving motor 351 generates a rotational driving force for rotating the driving cam in the forward direction or the reverse direction.

As described above, the controller 100 may be configured to control the handle driving motor 351 to extend the handle 31 to the first position Pd1 in response to that the person has been detected by the first sensor 210, and to control the handle driving motor 351 to extend the handle 31 to the second position Pd2 at which the handle has extended in the frontward direction beyond the first position Pd1 when a human hand is sensed by the second sensor 220.

The first limit switch 230 senses the position of the handle 31 due to the movement thereof and provides a sensing signal thereof to the controller 100. The retracted state of the handle 31 indicates a state in which the extended handle 31 has been displaced from the second position Pd2 to the first position Pd1 or the rearmost position, or the inserted position Pa, and has been inserted into the door 30. The first limit switch 230 may include at least one first limit switch which may respectively sense at least one position according to the movement of the handle.

The second limit switch 240 detects the opening and closing of the door 30 and provides a detection signal to the controller 100. The second limit switch 240 may include at least one second limit switch and may detect opening and closing of the door 30.

The control panel 32 may include a button 34 to which a user's manipulation input and a display 33 for displaying a current operating state. In addition, the control panel 32 may include a second LED module 260 for displaying the manipulation state of the button 34. The second LED module 260 may be used in the display 33 that displays the current operating state.

The first LED module 250 may be provided inside the handle 31. The plurality of LED elements 3221 of the first LED module 250 may be arranged along the upper line and the lower line of the front surface of the printed circuit board 322 and along the periphery of the handle 31. The first LED module 250 may be used as a welcome lighting. In addition, the first LED module 250 may be configured to emit light such that the color of the light varies according to a washing, rinsing, or drying cycle to indicate a cycle state.

In addition, the plurality of LED elements 3221 may be configured such that the number of turned on LED elements 3221 arranged in the left-right direction gradually increases according to the elapsed time duration of the washing, rinsing, or drying process and thus may be used as a lighting indicating the elapsed time duration. In addition, the plurality of LED elements 3221 may be configured to emit red light for a notification for preventing hand pinching. In addition, the plurality of LED elements 3221 may be configured to emit light such that the color of the light may vary according to the internal temperature of the dishwasher 1 and thus may be used as a lighting for warning of a safety accident.

The haptic motor 360 may be provided in the handle 31 and may act as one o the means for warning of hand pinching. In one example, the haptic motor 360 serves to generate vibration in the handle 31 upon detection that the hand is caught into between the handle 31 and the door 30.

The speaker and microphone 140 may be used to notify or guide a mode selection or an operation state of the dishwasher 1. In addition, the speaker and microphone 140 may be used to notify a warning when the hand pinching is detected or an action of opening the door 30 is detected in a state in which the internal temperature in the dishwasher 1 is high. In addition, the speaker and microphone 140 may be used to recognize the voice to control the dishwasher 1.

The controller 100 may be configured to receive an input signal from the control panel 32, to receive a detection signal from each of the sensors, and may control each load according to the input signal or the detection signal of each of the sensors.

The controller 100 may be configured to include at least one processor. The processor may include one or more of a central processing unit (CPU), an application processor, or a communication processor. Moreover, the controller 100 may be configured to include a timer 120. In addition, the controller 100 may be configured to include an analog-to-digital converter that converts a signal detected from the sensor into a digital signal. In addition, the controller 100 may be configured to include a driver for driving each of the motors. In addition, the controller 100 may be configured to include a driver for driving each of the LED modules. In addition, the controller 100 may be configured to include a driver for driving the touch electrode disposed in the handle. In addition, the controller 100 may communicate with a main controller that controls to perform washing, rinsing, and drying functions of the dishwasher 1.

For example, the controller 100 may be configured to include a touch driving circuit. The controller 100 may be configured to apply the touch driving signal TDS to the touch electrode of the second sensor 220 through the touch driving circuit TDC, and may receive a feedback signal from the touch electrode. The controller 100 may be configured to determine that the human hand is close to the handle 31 based on a detecting result of a change in the feedback signal due to the change in the capacitance between the human hand and the touch electrode.

A memory 130 may store therein data or a program for controlling the dishwasher 130. In addition, various parameters such as an operation condition and a time condition for each of the cycles pre-stored based on each washing course may be stored in the memory 130. In addition, data or a program for controlling the handle 31 may be stored in the memory 130.

A communication unit 60 may be used to communicate with an external terminal 70. For example, the communication unit 60 may communicate with a remote controller or a smart terminal of the user. An application for controlling or setting the dishwasher 1 may be installed in the smart terminal. The user may control the dishwasher 1 or set an operation mode through the smart terminal. For example, the user may use the remote controller or the smart terminal capable of communicating with the communication unit 60 to select and set the welcome lighting of the dishwasher 1.

In addition, the user may use a remote controller or a smart terminal capable of communicating with the communication unit 60 to select a handle movement mode for retracting the extended handle of the dishwasher 1. For example, in this regard, the handle movement mode may be set to one of an automatic retracting mode (or a first handle movement mode) in which the handle having extended from the front panel 30a of the door 30 automatically retracts to the inserted position Pa of the front panel, a semi-automatic retracting mode (or a second handle movement mode) in which the handle 310 retracts when a user command is input, and a handle position fixing mode (or a third handle movement mode) in which the extended state of the handle is maintained to be in a fixed state based on the sensor signal and the elapsed time duration.

In embodiments of the present disclosure, an example in which the handle 310 retracts into the door 30 when a two-touch as a user command is sensed by the second sensor 220 of the handle 31 in the second handle movement mode is set forth. However, embodiments of the present disclosure are not limited thereto. The user command may include a simple touch or two touch of the handle 310, a button input of the control panel 32 in addition to a touch of the handle 310, an input of the display 33, or the like.

Upon determination that the user approaches the dishwasher 1 based on the sensing result from the first sensor 210, the controller 100 may be configured to drive the handle driving motor 351 of the handle driver in the forward direction to move the handle 31 in the frontward direction to the first position Pd1.

In addition, in response to that the user's hand is sensed by the second sensor 220 after the handle 31 has been displaced to the first position Pd1, the controller 100 may be configured to additionally drive the handle driving motor 351 in the forward direction to move the handle 31 in then frontward direction to the second position Pd2.

In addition, in response to that a user's manipulation command is input from th control panel 32, the controller 100 may be configured to control the dishwasher 1 to turn on/off the power of the dishwasher 1 or to perform the individual cycle of the dishwasher 1 according to the selected washing course and the selected operation mode. In addition, the controller 100 may be configured to receive the user's manipulation command from the external terminal such as a remote controller or a smartphone via the communication unit 60.

In addition, the controller 100 may be configured to receive the detection signal from the first limit switch 230 and determine whether the handle 31 is at the first position Pd1, the second position Pd2, or the inserted position Pa based on the received detection signal.

In addition, the controller 100 may be configured to receive the detection signal from the second limit switch 240 and determine whether the door 30 is currently in a closed state or an open state based on the received detection signal. In addition, the controller 100 may be configured to extend or retract the handle according to the determination result. For example, when the opening of the door 30 is sensed by the second limit switch 240, the controller 100 may be configured to allow the handle 31 to extend to the second position Pd2 and turn on the first LED module 250 in a white color for 10 minutes. In addition, when the closing of the door 30 is sensed by the second limit switch 240, the controller 100 may be configured to maintain the extended state of the handle 31 for 5 seconds and then retract the handle to the inserted position Pa.

In addition, when the door 30 needs to be opened in a state in which the door 30 has been closed, the controller 100 may be configured to operate the handle driver to move the handle 31 in a frontward direction to the second position Pd2. For example, when a human hand is sensed by the second sensor 220 in a state in which the door 30 has been closed, the controller 100 may be configured to extend the handle 31 to the second position Pd2. In this regard, the controller 100 may be configured to flicker the first LED module 250 in a color varying according to the internal temperature of the dishwasher 1.

In addition, the controller 100 may be configured to determine whether a user's hand or another object is sandwiched between the handle 31 and the door 30 through a signal received from the second sensor 220. In addition, the controller 100 may be configured to determine whether a user's hand or another object is sandwiched between the handle 31 and the door 30 through a signal received from a current sensor (not shown) that detects overload of the handle driving motor 351 when the handle 31 moves backwards. In addition, in response to that the human hand is sensed as being present by the second sensor 220 of the handle 31, the controller 100 may be configured not to retract the handle 31.

In addition, when power is cut off, the controller 100 may be configured to allow the handle 31 to extend to the second position Pd2. For example, when power is cut off, the controller 100 may be configured to extend the handle 31 using a condenser or remaining power prepared so that the door 30 may be opened conveniently after a situation such as sudden power failure.

In addition, in response to that the person has been detected by the first sensor 210, the controller 100 may be configured to partially extend the handle 31 to the first position Pd1 and at the same time as the partial extending or subsequent thereto, to turn on the first LED module 250 in a welcome lighting mode.

In addition, the controller 100 may be configured to drive the haptic motor 360 to generate vibration when it is determined that a user's hand or an object is sandwiched between the handle 31 and the door 30 after the backward movement of the handle 31 is started through a signal received from the second sensor 220.

In addition, when the user's hand or object is caught into between the handle and the door based on the signal received from the second sensor 220, the controller 100 may be configured to generate a voice alarm or an acoustic alarm through the speaker 140 to guide the user to remove the hand or object from the handle 31. For example, the voice notification may include guidance information or warning information says “Please remove your hand form a handle. I'll close the handle” or “Please remove the object from the handle. I will close the handle”.

In addition, the controller 100 may be configured to invoke the operation condition, the time condition, etc. for each cycle based on each washing course pre-stored in the memory 130 and generate a control signal for controlling the execution and termination of the cycle according to the washing course using the operation condition or the time condition.

In addition, the controller 100 may be configured to receive a mode selection signal corresponding to selection of one of the automatic retracting mode and the semi-automatic retracting mode for retracting the handle 31 and the handle position fixing mode from the remote controller or the smart terminal, and may store the selected handle movement mode and the received mode selection signal in the memory 130.

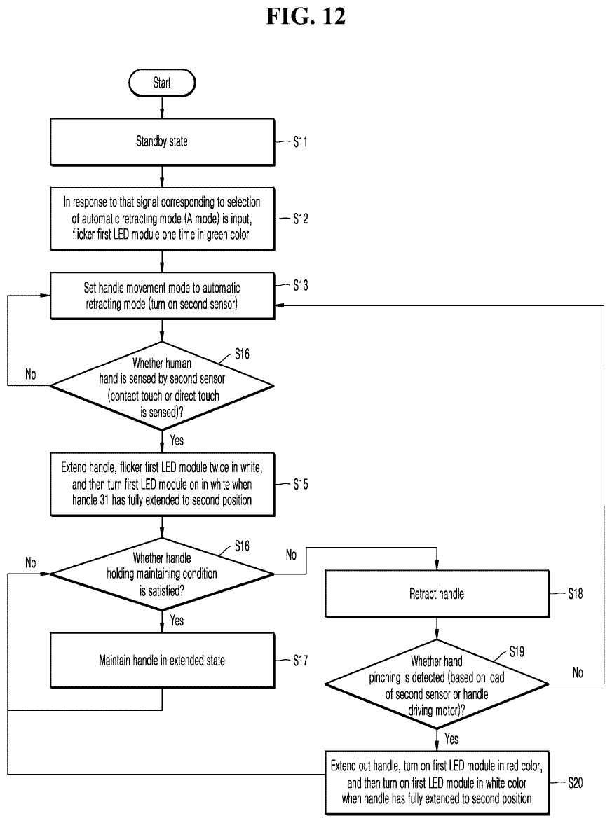

Hereinafter, a method for controlling the dishwasher 1 according to some embodiments of the present disclosure will be described with reference to FIGS. 12 to 14.

FIG. 12 is a flowchart illustrating a control method in the automatic retracting mode of the dishwasher according to an embodiment of the present disclosure.

Referring to FIG. 12, in response to that a signal corresponding to selection of the automatic retracting mode (the A mode or the first handle movement mode) is input from the terminal 70 in a standby state S11, the controller 100 of the dishwasher 1 flickers the first LED module 250 one time in a green color in S12, and sets the handle movement mode related to the retracting of the handle 31 to the automatic retracting mode in S13.

The controller 100 checks whether a human hand is sensed by the second sensor 220 of the handle 31 in S14. In this regard, the second sensor 220 may sense a non-contact touch or a direct touch in which the human hand has approached the handle 31 within 5 cm therefrom.

In response to that the human hand is sensed by the second sensor 220 of the handle 31, the controller 100 drives the handle driving motor 351 to extend the handle 31 in a frontward direction, flickers the first LED module 250 twice in white, and then turns the first LED module 250 on in white when the handle 31 has fully extended to the second position Pd2 in S15.

The controller 100 checks whether a handle holding maintaining condition of the handle 31 is satisfied in a state in which the handle has extended in S16. In this regard, the controller 100 may be configured to determine whether the handle holding maintaining condition is satisfied based on the respective detection signals of the sensors and the elapsed time duration related to the handle holding maintaining condition. For example, in response to that there is no input of a sensing signal of each of the sensors or there is no user input for a predetermined time duration or greater after the human hand has been sensed by the second sensor 220, the controller 100 may be configured to determine that the handle holding maintaining condition is not satisfied. In addition, for example, when a start button is pressed and the closed state of the door 30 is sensed, the controller 100 may be configured to determine that the handle holding maintaining condition is not satisfied.

In response to that the handle holding maintaining condition is satisfied in the state in which the handle 31 has extended, the controller 100 maintains the handle 31 in the extended state in S17.

In response to that the handle holding maintaining condition is not satisfied in the state which the handle 31 has extended, the controller 100 allows the handle 31 to retract in S18. In this regard, the handle 31 may retract to the first position (partially-extended position) Pd1 or the inserted position Pa according to the operating state of the dishwasher. For example, in response to that the start button instructing start of the washing or rinsing operation of the dishwasher 1 is pressed and the closed state of the door is sensed, the controller 100 may be configured to allow the handle 31 to move to the first position Pd1. In addition, for example, in response to that there is no input of the sensing signal of each sensor or there is no user input for a predetermined time or greater after the human hand on the handle 31 has been sensed, the controller 100 may be configured to allow the handle 31 to move to the inserted position Pa.

The controller 100 checks whether a hand pinching is detected while driving the handle driving motor 351 such that the handle 31 retracts in S19. For example, the controller 100 may be configured to detect a load of the second sensor 220 of the handle 31 or a load of the handle driving motor 351 to check whether the object is caught into between the handle 31 and the door 30.

When the handle 31 is caught into therebetween, the controller 100 drives the handle driving motor 351 to extend out the handle 31, turns on the first LED module 250 in a red color, and then turns on the first LED module 250 in a white color when the handle 31 has fully extended to the second position Pd2 in S20.

As described above, in response to that the handle movement mode of the handle 31 is set to the automatic retracting mode, the dishwasher 1 may maintain the extended state of the handle 31 or automatically retract the extended handle, based on the detection signal of each of the sensors.

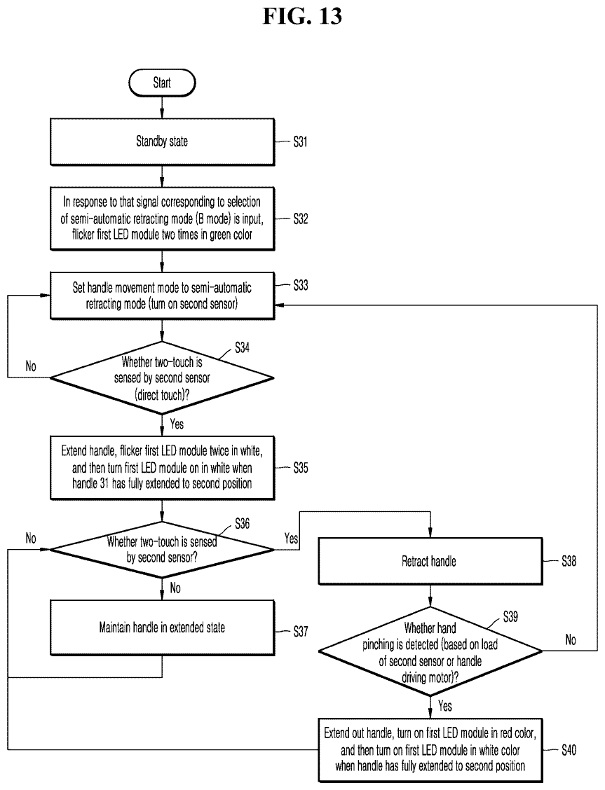

FIG. 13 is a flowchart illustrating a control method in a semi-automatic retracting mode of a dishwasher according to an embodiment of the present disclosure.

Referring to FIG. 13, when a signal corresponding to selection of the semi-automatic retracting mode (the B mode or the second handle movement mode) is input from the terminal 70 in the standby state S31, the controller 100 of the dishwasher 1 flickers the first LED module 250 two times in a green color in S32, and sets the handle movement mode related to the retracting of the handle 31 to the semi-automatic retracting mode in S33.

The controller 100 checks whether the two-touch is sensed by the second sensor 220 of the handle 31 in S34. In this regard, the second sensor 220 may sense a direct touch of the handle 31.

In response to that the two-touch is sensed by the second sensor 220 of the handle 31, the controller 100 drives the handle driving motor 351 to extend the handle 31 in a frontward direction, flickers the first LED module 250 twice in white, and then turns the first LED module 250 on in white when the handle 31 has fully extended to the second position Pd2 in S35.

The controller 100 checks whether the handle holding maintaining condition is satisfied in the state in which the handle 31 has extended, that is, checks whether a two-touch is sensed by the second sensor 220 of the handle 31 in S36.

In response to that the handle holding maintaining condition is satisfied in the state in which the handle 31 has extended, that is, the two-touch is not sensed by the second sensor 220 of the handle 31, the controller 100 maintains the handle 31 in the extended state in S37.

In response to that the handle holding maintaining condition is not satisfied in the state in which the handle 31 has extended, that is, the two-touch is sensed by the second sensor 220 of the handle 31 in the state in which the handle 31 has extended, the controller 100 allows the handle 31 to retract into or toward the door. in S38. In this regard, the handle 31 may retract to the first position Pd1 or the inserted position Pa according to the operating state of the dishwasher.

The controller 100 checks whether the hand pinching is detected while driving the handle driving motor 351 such that the handle 31 retracts in S39. For example, the controller 100 may be configured to detect a load of the second sensor 220 of the handle 31 or a load of the handle driving motor 351 to check whether the object is caught into between the handle 31 and the door 30.

In response to that the handle 31 is caught into therebetween, the controller 100 drives the handle driving motor 351 to extend out the handle 31, turns on the first LED module 250 in a red color, and then turns on the first LED module 250 in a white color when the handle 31 has fully extended to the second position Pd2 in S40.

When the handle movement mode of the handle 31 is set to the semi-automatic retracting mode, the dishwasher 1 may maintain the extended state of the handle 31 or retract the extended handle 31 according to whether two touches on the handle 31 has been detected.

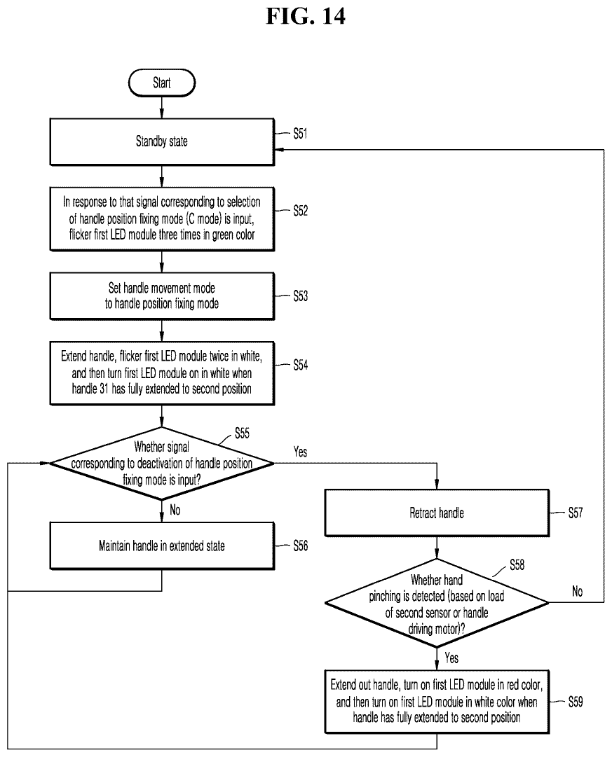

FIG. 14 is a flowchart illustrating a control method in a handle position fixing mode of a dishwasher according to an embodiment of the present disclosure.

Referring to FIG. 14, in response to that a signal corresponding to selection of the handle position fixing mode (C mode or the third handle movement mode) is input from the terminal 70 in the standby state S51, the controller 100 of the dishwasher 1 flickers the first LED module 250 three times in green in S52 and sets the handle movement mode related to the retracting of the handle 31 to the handle position fixing mode in S53.

In response to that the handle movement mode has been set to the handle position fixing mode, the controller 100 drives the handle driving motor 351 to extend the handle 31 in a frontward direction, and maintains the handle 31 in the extended state in S54. In this regard, the controller 100 flickers the first LED module 250 two times in a white color, and turns the first LED module 250 on in a white color when the handle 31 has fully extended to the second position Pd2 in S54.

The controller 100 checks whether a signal corresponding to deactivation of the handle position fixing mode is input from the terminal 70 in S55. When the signal corresponding to the deactivation of the handle position fixing mode is not input, the controller 100 maintains the extended state of the handle 31 in S56.

In response to that the signal corresponding to the deactivation of the handle position fixing mode has been input from the terminal 70 in a state in which the handle 31 has extended, the controller 100 allows the handle 31 to retract in S57. In this regard, the handle 31 may retract to the first position Pd1 or the inserted position Pa according to the operating state of the dishwasher.

The controller 100 checks whether the hand pinching is detected while driving the handle driving motor 351 such that the handle 31 retracts in S58. For example, the controller 100 may be configured to detect a load of the second sensor 220 of the handle 31 or a lad of the handle driving motor 351 to check whether the object is caught into between the handle 31 and the door 30.

In response to that the handle 31 is caught into therebetween, the controller 100 drives the handle driving motor 351 to extend out the handle 31, turns on the first LED module 250 in a red color, and then turns on the first LED module 250 in a white color when the handle 31 has fully extended to the second position Pd2 in S59.

In this way, when the handle movement mode of the handle 31 is set to the handle position fixing mode, the dishwasher 1 may fix the handle 31 in the extended state. Then, in response to that the signal corresponding to the deactivation of the handle position fixing mode has been input, the dishwasher 1 may retract the handle 31.

In one example, a command related to the opening and closing of the door 30 may have a higher level than the handle movement mode. That is, the handle related movement instructed by the command related to the opened and closed states of the door 30 may be executed regardless of the handle movement mode. More specifically, the controller 100 of the dishwasher 1 may extend or retract the handle 31 according to the opened or closed state of the door 30 regardless of the handle movement mode. For example, when the opening of the door 30 is detected through the second limit switch 240 after the washing or rinsing cycle of the dishwasher 1 has been completed, the controller 100 may be configured to allow the handle 31 to extend regardless of the handle movement mode. For example, in response to that the start button has been pressed on the control panel and the closing of the door 30 is detected through the second limit switch 240, the controller 100 may be configured to allow the handle 31 to retract after maintaining the extended state of the handle 31 for 5 seconds, regardless of the handle movement mode.

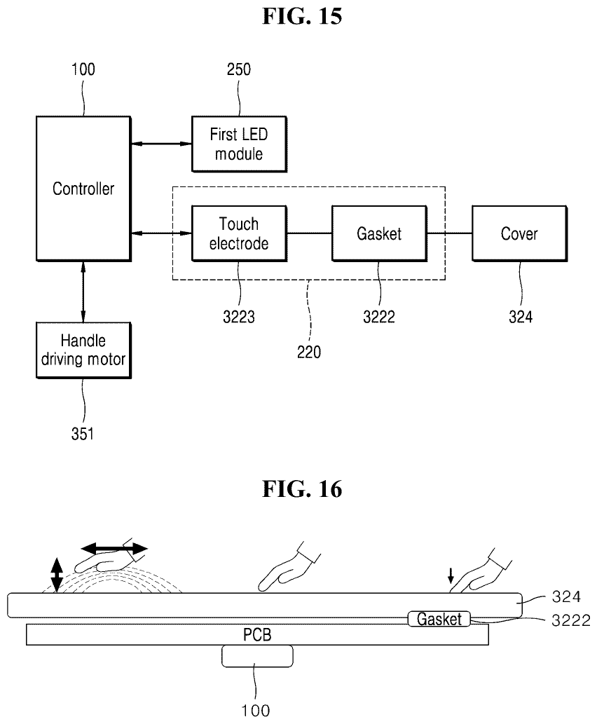

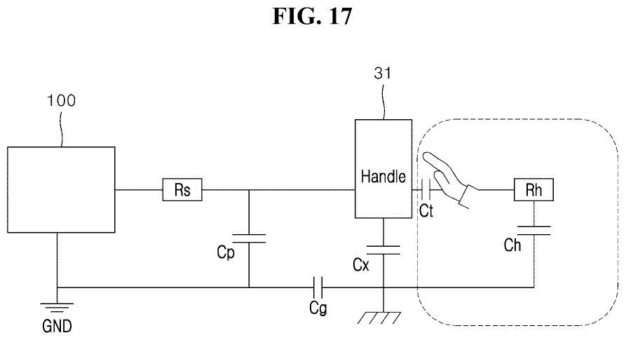

FIG. 15 is a block diagram of an example of a control device in a dishwasher according to an embodiment. FIGS. 16 and 17 are diagrams for illustrating human hand sensing by a sensor disposed in a handle.

Referring to the drawings, the second sensor 220 is disposed on the handle 31 of the dishwasher 1, and includes a touch electrode 3223 and the gasket 3222. The touch electrode 3223 and the gasket 3222 may be mounted on the printed circuit board 322 (see FIG. 7.

The gaskets 3222 may be arranged along a vertical center line of the front surface of the printed circuit board 322 in the left-right direction. One side of the gasket 3222 may be in contact with the touch electrode 3223, and the other side of the gasket 3222 may be in contact with the handle cover 323. For example, the handle cover 324 may be made of a material such as metal, glass, or a film.

The second sensor 220 may sense whether the human hand is in proximity to the dishwasher and whether the touch is made on the handle based on a sensing result of a change in capacitance between the touch electrode 3223 and the user's hand when the user touches the front surface of the handle cover 324 of the handle 31 in a non-contact manner or a contact manner.

In response to that the presence of the human hand is sensed by the second sensor 220, the controller 100 may be configured to drive the handle driving motor 351 to extend the handle 31 in a frontward direction from the front panel 30a of the door 30, and may turn on or off the first LED module 250 in the color varying according to the operating state of the dishwasher 1.

As shown, the second sensor 220 may sense the touch using the handle cover 324 of the handle 31. In this regard, the handle cover 324 is in contact with the gasket 3222, and the gasket 3222 is connected to the touch electrode 3223 mounted on the printed circuit board PCB. In addition, a capacitive touch sensor may be used to identify the user's intention to open the door in a non-contact proximity (or air touch) sensing, contact sensing, pressure sensing, or non-contact gesture (or air gesture) manner.

In FIG. 17, Ch denotes a capacitance between a person and a ground, Rs denotes a resistance of a person, Ct denotes a touch capacitance between the handle 31 and a human hand, Cx denotes a free space capacitance between the 31 handle and a ground, Cp denotes a ground return capacitance, Cp denotes a parasitic capacitance, and Rs denotes a source resistance between the controller 100 and the handle 31.

When a non-contact touch or a direct touch on the handle 31 occurs, a parallel earth path passing through the human body is added, such that a total capacitance value resulting from the touch capacitance Ct increases. This change in the total capacitance may be used to detect whether the touch of the human hand on the handle 31 occurs.

A home appliance according to an embodiment of the present disclosure may include a door; a handle configured to extend from the door or retract into the door, wherein a handle movement mode of the handle is selected or changed by a user; a sensor disposed on the handle and configured to sense a human hand; and a controller configured to receive the handle movement mode of the handle selected or changed by the user, and to extend or retract the handle from or into the door or maintain a position of the handle in the extended state, based on the selected handle movement mode and a detection signal from the sensor.

A home appliance according to an embodiment of the present disclosure may include: a door; a handle configured to extend from the door or retract into the door, wherein a handle movement mode of the handle is selected or changed by a user; a sensor disposed on the handle and configured to sense a human hand; a light source module disposed in the handle; a handle position detection sensor configured to detect a position of the handle according to movement of the handle; a door opening/closing detection sensor configured to detect opening/closing of the door; a handle driving motor configured to drive the handle to extend in a frontward direction from the door or retract in a rearward direction into the door; and a controller configured to receive the handle movement mode of the handle selected or changed by the user, and to extend or retract the handle from or into the door or maintain a position of the handle in the extended state, based on the selected handle movement mode and a detection signal from each of the sensors.

A home appliance according to an embodiment of the present disclosure may include a door; a handle configured to extend from the door or retract into the door, wherein a handle movement mode of the handle is selected by a user; a sensor disposed on the door or the handle and configured to sense an input from the user; and a controller configured to receive the handle movement mode of the handle selected by the user, and to extend or retract the handle from or into the door or maintain a position of the handle in the extended state, based on the selected handle movement mode and a detection signal from the sensor.

A home appliance according to an embodiment of the present disclosure may include: a door; a handle configured to extend from the door or retract into the door, wherein a handle movement mode of the handle is selected by a user; a user input detection sensor disposed on the door or the handle and configured to sense an input from the user; a handle position detection sensor configured to detect a position of the handle according to movement of the handle; a door opening/closing detection sensor configured to detect opening/closing of the door; a handle driving motor configured to drive the handle to extend in a frontward direction from the door or retract in a rearward direction into the door; and a controller configured to receive the handle movement mode of the handle selected by the user, and to extend or retract the handle from or into the door or maintain a position of the handle in the extended state, based on the selected handle movement mode and a detection signal from each of the sensors.

Although the embodiments of the present disclosure have been described above in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A home appliance comprising:
a door;
a handle configured to extend from the door or retract into the door based on a handle movement mode being selected by a user;
a sensor disposed on the door or the handle and configured to sense an input from the user; and
a controller configured to receive the handle movement mode selected by the user, the controller being configured to (i) extend or retract the handle from or into the door or (ii) maintain a position of the handle in an extended state, based on the selected handle movement mode and a detection signal from the sensor.

2. The home appliance of claim 1, wherein the handle movement mode includes:
a first handle movement mode in which the handle automatically retracts after the handle has extended;
a second handle movement mode in which the handle retracts in response to that a user command is input; and
a third handle movement mode in which the position of the handle is maintained in the extended state.

3. The home appliance of claim 2, wherein one of the first to third handle movement modes is selected by the user through an external terminal capable of communicating the home appliance or on a control panel or a display of the home appliance.

4. The home appliance of claim 2, wherein in the first handle movement mode, the controller is configured to maintain the position of the handle in the extended state of the handle or automatically retract the handle into or toward the door based on whether a handle holding maintaining condition is satisfied.

5. The home appliance of claim 4, wherein in the first handle movement mode,
the controller is configured to:
determine whether the handle holding maintaining condition is satisfied based on at least one of the detection signal of the sensor and an elapsed time duration; and
retract the handle based on a result of the determination.

6. The home appliance of claim 2, wherein in the second handle movement mode, in response to that the user command is input, the controller is configured to extend or retract the handle based on a current position of the handle.

7. The home appliance of claim 2, wherein in the third handle movement mode,
in response to that a selection signal of the third handle movement mode is input, the controller is configured to maintain a position of the handle in the extended state,
in response to that a signal of deactivating the third handle movement mode is input, the controller is configured to retract the handle.

8. The home appliance of claim 2, wherein a light source module is disposed in the handle,
wherein the controller is configured to turn on the light source module in a lighting pattern varying based on selected one of the first to third handle movement modes.

9. The home appliance of claim 1, wherein the home appliance is a dishwasher,
wherein a handle movement is executed based on an open or closed state of the door regardless of the selected handle movement mode,
wherein in response to that the opening of the door is sensed after operation of the dishwasher has been completed, the controller is configured to extend the handle from the door.

10. The home appliance of claim 9, wherein the handle movement is executed based whether a start button of the dishwasher is pressed regardless of the selected handle movement mode,
wherein in response to that the start button of the dishwasher is pressed and the closing of the door is sensed, the controller is configured to retract the handle after a predetermined time duration has elapsed from the sensing of the closing of the door.

11. The home appliance of claim 1, wherein the selected handle movement mode is selected by the user through an external terminal capable of communicating the home appliance or on a control panel or a display of the home appliance.

12. The home appliance of claim 1, wherein the handle movement mode includes:
a movement mode in which the handle extends or retracts; and
a maintained mode in which the position of the handle is maintained in the extended state.

13. A home appliance comprising:
a door;
a handle configured to extend from the door or retract into the door, wherein a handle movement mode of the handle is selected by a user;
a user input detection sensor disposed on the door or the handle and configured to sense an input from the user;
a handle position detection sensor configured to detect a position of the handle according to movement of the handle;
a door opening/closing detection sensor configured to detect opening/closing of the door;
a handle driving motor configured to drive the handle to extend in a frontward direction from the door or retract in a rearward direction into the door; and
a controller configured to receive the handle movement mode of the handle selected by the user, the controller being configured to (i) extend or retract the handle from or into the door or (ii) maintain a position of the handle in the extended state, based on the selected handle movement mode and a detection signal from each of the user input detection sensor, the handle position detection sensor, and the door opening/closing detection sensor.

14. The home appliance of claim 13, wherein in response to that an automatic retracting mode is selected as the handle movement mode, the controller is configured to maintain a position of the handle in the extended state or to drive the handle driving motor to automatically retract the handle into or toward the door, based on whether a handle holding maintaining condition is satisfied.

15. The home appliance of claim 14, wherein in the automatic retracting mode, in response to that no user input or human hand is detected for a predetermined time duration after the handle has extended, the controller is configured to drive the handle driving motor to automatically retract the handle into or toward the door.

16. The home appliance of claim 13, wherein, in response to (i) a semi-automatic retracting mode being selected as the handle movement mode, and (ii) a user command being input to the handle, the controller is configured to extend or retract the handle based on a current position of the handle sensed using the handle position detection sensor.

17. The home appliance of claim 13, wherein in response to that a handle position fixing mode is selected as the handle movement mode, the controller is configured to maintain a position of the handle in the extended state,
wherein in response to that a signal corresponding to deactivation of the handle position fixing mode is input from an external terminal, the controller is configured to drive the handle driving motor to retract the handle into or toward the door.

18. The home appliance of claim 13, wherein the handle movement mode is selected or changed according to a signal received from an external terminal communicating with the home appliance or a user input onto a control panel or a display of the home appliance.

19. The home appliance of claim 13, wherein the home appliance is a dishwasher,
wherein a handle movement is executed based on an open or closed state of the door regardless of the selected handle movement mode,
wherein in response to that the opening of the door is detected using the door opening/closing detection sensor after operation of the dishwasher has been completed, the controller is configured to drive the handle driving motor to extend the handle from the door.

20. The home appliance of claim 1, wherein the home appliance includes a dishwasher, a clothing care apparatus, a laundry treating apparatus, a dryer, or a refrigerator in which the door and the handle are configured to be visible to an outside.
